(19) United States
(12) Patent Application Publication
(10) Pub. No.: US 2018/0107990 A1
(43) Pub. Date: Apr. 19, 2018

(54) SYSTEMS AND METHODS OF DISPATCHING CONTRACTOR SERVICES

(71) Applicant: Robert Dale BEADLES, Lodi, CA (US)

(72) Inventor: Robert Dale BEADLES, Lodi, CA (US)

(21) Appl. No.: 15/787,663

(22) Filed: Oct. 18, 2017

Related U.S. Application Data
(60) Provisional application No. 62/409,407, filed on Oct. 18, 2016.

(51) Int. Cl. G06Q 10/00

(52) U.S. Cl. CPC G06Q 10/20; G06F 3/0482

(57) ABSTRACT

Methods and Apparatus are provided that allow consumers to select from a hierarchical display of contractor service contractors using a variety of selection criteria. Methods and Apparatus are provided in which a graphical user interface comprising a plurality of selectable contractor service categories is displayed. A selection of at least one of the plurality of selectable contractor service categories is received as is a service location and a contractor service job type. Iterating through a hierarchical list of contractor service individuals is achieved by: transmitting, in an iterative manner, a work order that comprises the service location and the contractor service job type until a confirmation is received from at least one of the contractor service individuals.

### CROSS REFERENCE TO RELATED APPLICATIONS

This application claims the priority benefit of U.S. Provisional Application Ser. No. 62/409,407, filed on Oct. 18, 2016, entitled “SYSTEMS AND METHODS OF DISPATCHING CONTRACTOR SERVICES”, which is hereby incorporated by reference herein in its entirety, including all reference cited therein.

### FIELD OF THE INVENTION

The present technology is directed to contractor service dispatching, and more particularly, but no by limitation, to systems and methods that allow consumers to select from a hierarchical display of contractor service contractors using a variety of selection criteria.

### SUMMARY

According to one aspect, there is provided a method that can comprise: displaying a graphical user interface that comprises a plurality of selectable contractor service categories; receiving a selection of at least one of the plurality of selectable contractor service categories; receiving a service location and a contractor service job type; and iterating through a hierarchical list of contractor service individuals by: transmitting, in an iterative manner, a work order that comprises the service location and the contractor service job type until a confirmation is received from at least one of the contractor service individuals.

The selectable contractor service categories can comprise any of electrical, plumbing, gardening, general repair, HVAC, and garbage removal services.

According to another aspect, there is a provided a computer-readable medium including contents that are configured to cause a computing system to confirm a dispatch order of a contractor service by performing a method that can comprise: displaying a graphical user interface that comprises a plurality of selectable contractor service categories; receiving a selection of at least one of the plurality of selectable contractor service categories; receiving a service location and a contractor service job type; and iterating through a hierarchical list of contractor service individuals transmitting, in an iterative manner, an order that comprises the service location and the contractor service job type until a confirmation is received from at least one of the contractor service individuals.

The selectable contractor service categories can comprise any of electrical, plumbing, gardening, general repair, HVAC, and garbage removal services.

According to yet another aspect, there is provided an apparatus that can comprise a memory storing instructions; and one or more processors, wherein said instructions, when processed by the one or more processors, can cause: displaying a graphical user interface that comprises a plurality of selectable contractor service categories; receiving a selection of at least one of the plurality of selectable contractor service categories; receiving a service location and a contractor service job type; and iterating through a hierarchical list of contractor service individuals by: transmitting, in an iterative manner, an order that comprises the service location and the contractor service job type until a confirmation is received from at least one of the contractor service individuals.

The selectable contractor service categories can comprise any of electrical, plumbing, gardening, general repair, HVAC, and garbage removal services.

### BRIEF DESCRIPTION OF THE DRAWINGS

FIG. 1 is a flowchart of an example method of the present disclosure;

FIG. 2 is a schematic diagram of various mock GUIs that can be used to practice the methods described herein according to some embodiments;

FIG. 3 illustrates an example user profile and various attributes of the user profile that can be edited according to some embodiments;

FIG. 4 illustrates another flow diagram of a method of the present disclosure, illustrating additional data utilized in the various methods of the present disclosure according to some embodiments.

FIG. 5 illustrates an example contractor service category GUI and an example dispatch request GUI according to some embodiments; and

FIG. 6 is a diagrammatic representation of an embodiment of a machine in the form of a computer system.

### DETAILED DESCRIPTION OF PREFERRED EMBODIMENTS

Generally, the present disclosure is directed to systems and methods for dispatching contractor service individuals using an application. In some embodiments application provides graphical user interfaces (GUIs) that provide selections of contractor service categories, contractor services job types, and contractor service individuals (e.g., contractors) within the individual contractor service categories. The contractor service individuals can be ranked in a hierarchical manner based on ratings, location, expertise, cost, and/or other parameters and combinations of parameters.

The application is executable on the customer's device and provides the user with an initial landing page that provides various selectable contractor service categories such as Auto Detailing, Childcare, Roofing, HVAC, Plumbing, General Handyman, Electric, and so forth. When any of the contractor service categories is selected by the customer another GUI is called that allows the customer to select from one or more contractor services job types that are related to the general contractor service category. For example, with an HVAC service request the user can select New Equipment Sales, Equipment Repair, and other similar categories.

When selected, another GUI can be displayed that allows the customer to select a Confirm option. In some embodiments the GUI can include a form section that allows the customer to select the location (service area) where the contracting service is desired. To be sure, the location of the customer can be determined from location information gathered from the customer's device. The application can provide the customer with a success screen or other confirmation that indicates that the selected service has been dispatched. In some embodiments the confirmation can comprise an estimated time of arrival for the contractor service individual that was selected by the customer.

In one embodiment the application can cause the transmission of an email, text message, or actual voice call to the contractor service individual in the category to be dispatched. In some embodiments, the application automatically selects the contractor service individual from a plurality of available contractor service individuals based on expertise, availability, customer rating, and/or other factors. If the selected contractor service individual is not available, the application will iterate through a hierarchical list of contractor service individuals that are ranked based on any of the aforementioned parameters. This iteration occurs until a contractor service individual accepts the contractor service request.

In one or more embodiments the automated request will reach out to each contractor service individual in a method which is predetermined by each of the contractor service individuals such as phone call, text, and email.

The automated request states the nature of work, location, and desired timeframe. The contractor service individual will respond to the automated request with simple key touches on the phone or text, such as depressing “1” on their keypad to accept or “2” to decline, for example. The original requestor is notified at each step of the process for example if a vendor declines, accepts, and so forth. Specific details of this request are logged into a company system of an employer of the contractor service individual.

In another example embodiment, the contractor service individual will use an application on their client device (e.g., Smartphone) that includes contractor service GUIs that allow the contractor to build profiles, receive and decline offers, and review customers—just to name a few.

In some embodiments, the selection of a contractor service individual would be determined based on various criteria, as mentioned above. In one embodiment, a division would drive the selection of a MSA (master service agreement) from a company of the contractor or a general contract when the contractor is an individual contractor. A service area and a service category can be used to select possible MSAs.

In some embodiments, a company that employs contractor service individuals assigns a priority structure to the MSA so as to define a tier structure for how the contractor service individuals are selected. For example, the company can specify that contractors in close proximity to the service request area have priority in responding to a request for work over even slightly higher contractors that are not close enough to service the customer in a reasonable time period.

When the contractor service individual confirms acceptance of a contractor service job a request number is assigned. The contractor service individual is sent an ‘email’ and/or ‘text message’ and/or ‘automated phone call’ and/or ‘Application Notification’ of request for work. As mentioned above, the contractor service individuals utilize an end user device that also executes a contractor version of the Application. If the contractor service individual accepts then a confirmation is sent to the company of the contractor service individual.

If the contractor service individual declines then request is sent to the next contractor service individual on the tier.

Once a contractor service individual accepts the service request then confirmation is sent to the contractor service individual's company and request is turned into an order.

In some embodiments requests and orders are stored in a queue managed by the application.

A requestor is able to see all requests and completed orders, in some embodiments. Once an order has been completed the contractor service individual or company will have the ability to place a rating against a work order, as well as provide commentary. The contractor can likewise review the customer.

The contractor service individual version of the application can display requested, rejected, and completed work orders. The application also displays ratings for each order, on a per contractor service individual basis.

The application can also provide report showing a detail as well as a cumulative view of ratings per category and contractor.

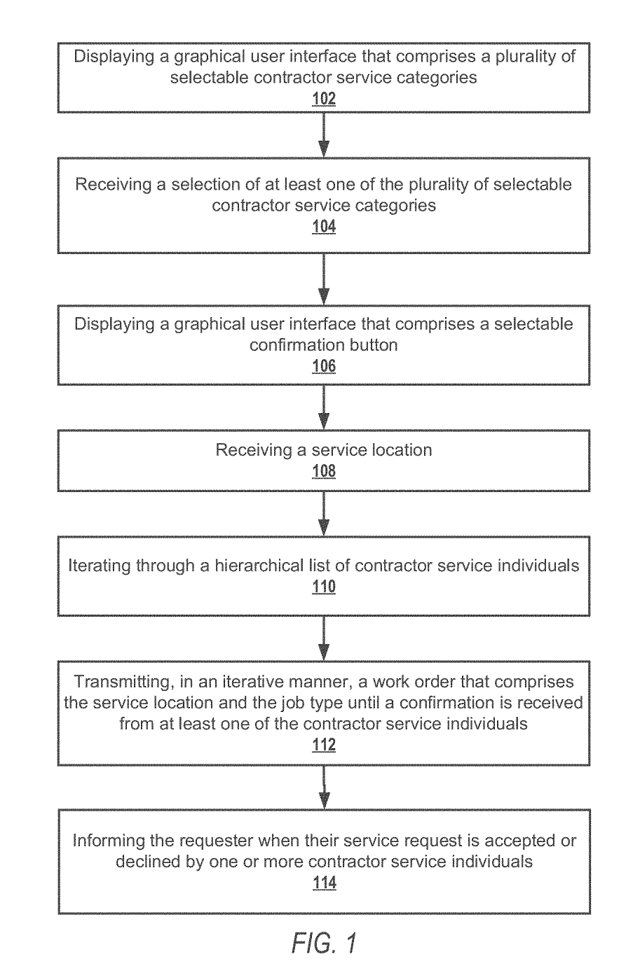

FIG. 1 is a flowchart of an example method of the present disclosure. The method includes a step 102 of displaying a graphical user interface that comprises a plurality of selectable contractor service categories. The end user selects the particular contractor service category that applies to their situation. In one embodiment the situation comprises a request for maintenance on an electrical junction box, so the user selects “Electric.”

The method also includes a step 104 of receiving a selection of at least one of the plurality of selectable contractor service categories. One embodiment includes new service, maintenance, and emergency. The user would select maintenance in this example.

In one embodiment, the method includes a step 106 of displaying a graphical user interface that comprises a selectable confirm button.

The method includes a step 108 of receiving a service location. In one embodiment, a webform is displayed and the user enters their address in the webform.

In one embodiment, the method comprises a step 110 of iterating through a hierarchical list of contractor service individuals that includes a step 112 of transmitting, in an iterative manner, a work order that comprises the service location and the contractor service job type until a confirmation is received from at least one of the contractor service individuals. The order and information can be included in a message that is transmitted through SMS, MMS, email, voice, or the like. The order can include any pertinent information for the service request.

In one embodiment, the method can comprise a step 114 of informing the requester when their service request is accepted or declined by one or more contractor service individuals.

In some embodiments, various reports are generated and displayed.

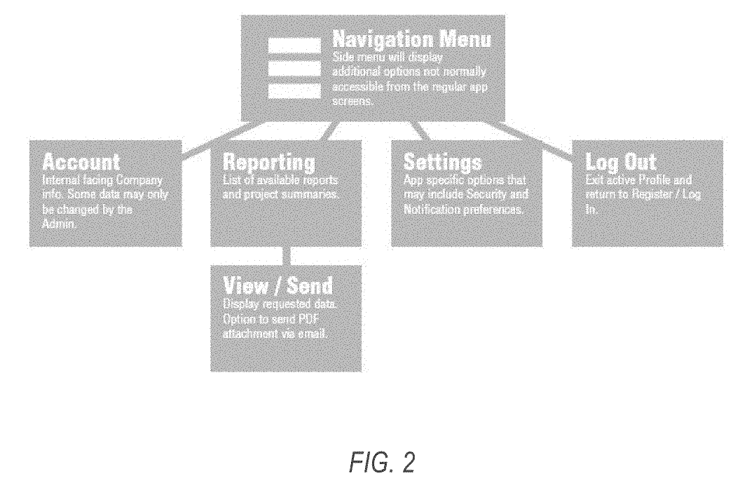

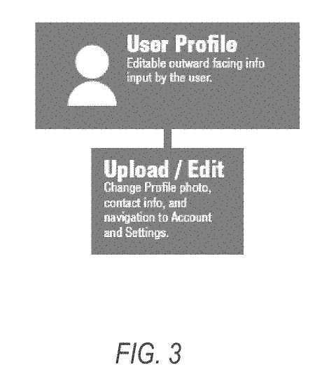

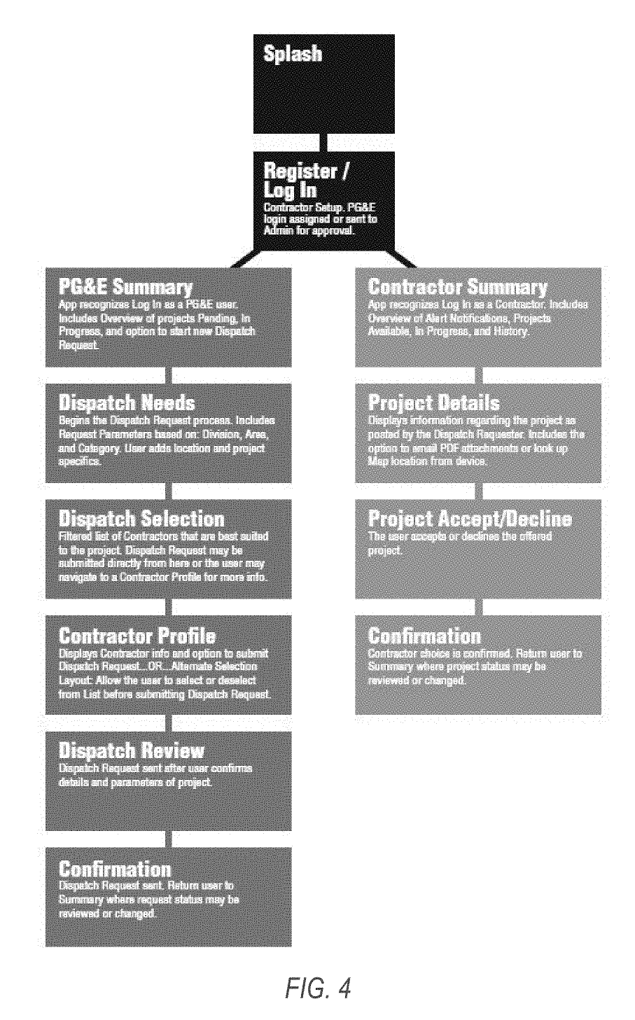

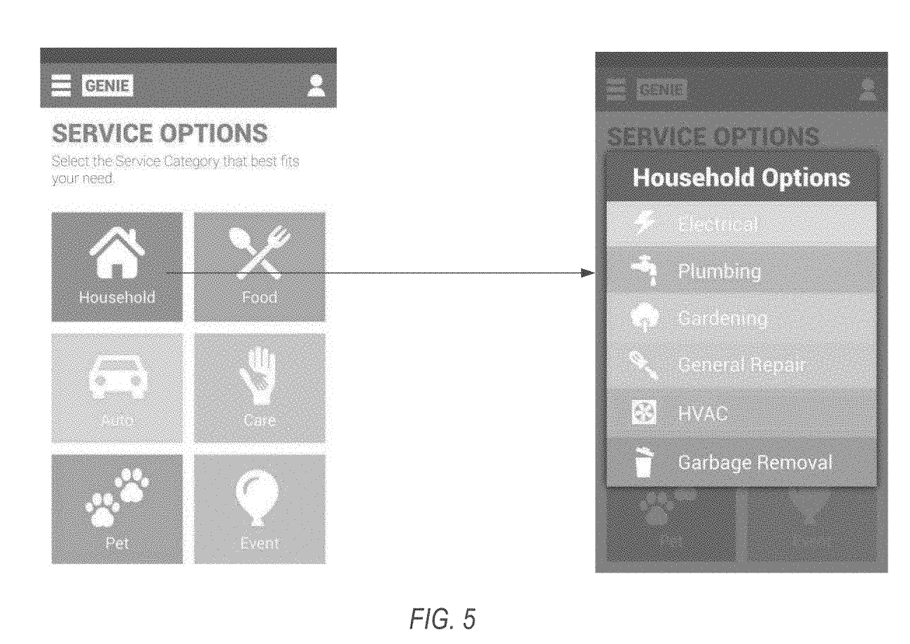

FIG. 2 is a schematic diagram of various mock GUIs that can be used to practice the methods described herein. FIG. 3 illustrates an example user profile and various attributes of the user profile that can be edited. FIG. 4 illustrates another flow diagram of a method of the present disclosure, illustrating additional data utilized in the various methods of the present disclosure. FIG. 5 illustrates an example contractor service category GUI and an example dispatch request GUI. The various instances of selectable service categories comprise, but are not limited to household (e.g., handyman), food, automotive, care (e.g., childcare and eldercare), pet, and event. When the household service category is selected a household options GUI is displayed that includes a list of selectable sub-services such as electrical, plumbing, gardening, general repair, HVAC, and garbage removal—just to name a few. Once selected, the system and methods disclosed here can be utilized to select any appropriate contractor for provision of services.

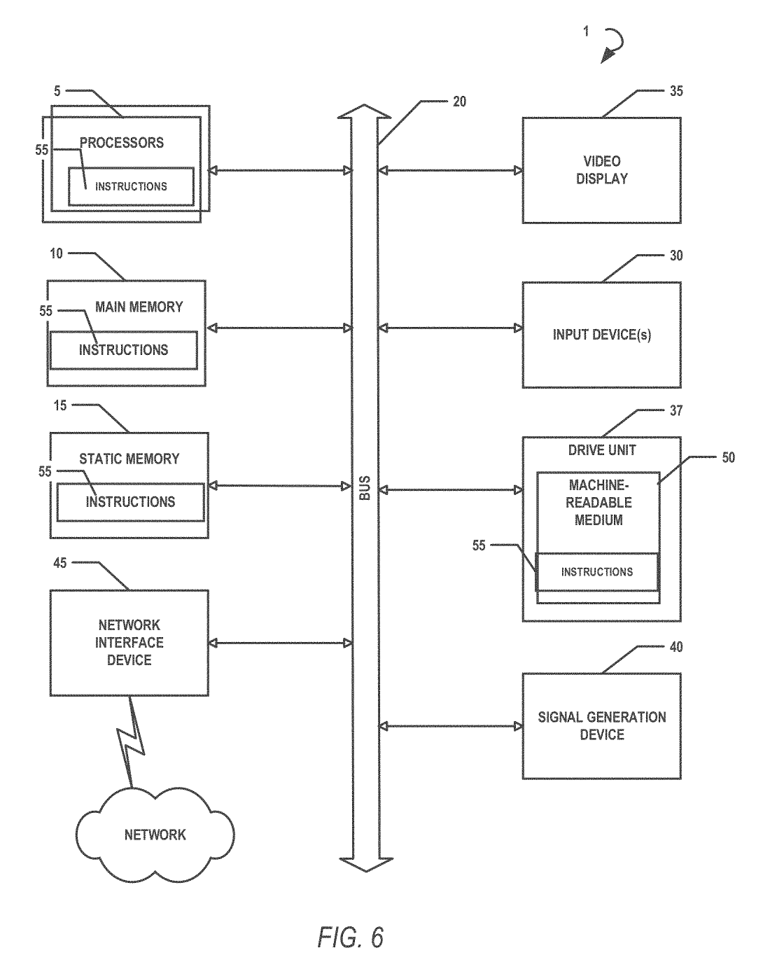

FIG. 6 is a diagrammatic representation of an embodiment of a machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The embodiment of the computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In other embodiments, any one or more of the method or process steps or blocks shown in the flow chart may be omitted or re ordered in relation to the other steps or blocks.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
displaying a graphical user interface that comprises a plurality of selectable contractor service categories;
receiving a selection of at least one of the plurality of selectable contractor service categories;
receiving a service location and a contractor service job type; and
iterating through a hierarchical list of contractor service individuals by:
transmitting, in an iterative manner, a work order that comprises the service location and the contractor service job type until a confirmation is received from at least one of the contractor service individuals.

2. The method of claim 1, wherein said selectable contractor service categories comprises any of electrical, plumbing, gardening, general repair, HVAC, and garbage removal services.

3. A computer-readable medium including contents that are configured to cause a computing system to confirm a dispatch order of a contractor service by performing a method comprising:
displaying a graphical user interface that comprises a plurality of selectable contractor service categories;
receiving a selection of at least one of the plurality of selectable contractor service categories;
receiving a service location and a contractor service job type; and
iterating through a hierarchical list of contractor service individuals by:
transmitting, in an iterative manner, an order that comprises the service location and the contractor service job type until a confirmation is received from at least one of the contractor service individuals.

4. The computer-readable medium of claim 3, wherein said selectable contractor service categories comprises any of electrical, plumbing, gardening, general repair, HVAC, and garbage removal services.

5. An apparatus, comprising:
a memory storing instructions; and
one or more processors, wherein said instructions, when processed by the one or more processors, cause:
displaying a graphical user interface that comprises a plurality of selectable contractor service categories;
receiving a selection of at least one of the plurality of selectable contractor service categories;
receiving a service location and a contractor service job type; and
iterating through a hierarchical list of contractor service individuals by:
transmitting, in an iterative manner, an order that comprises the service location and the contractor service job type until a confirmation is received from at least one of the contractor service individuals.

6. The apparatus of claim 5, wherein said selectable contractor service categories comprises any of electrical, plumbing, gardening, general repair, HVAC, and garbage removal services.
